(19) United States
(12) Patent Application Publication
(10) Pub. No.: US 2011/0211135 A1
(43) Pub. Date: Sep. 1, 2011

(54) Bendable liquid crystal polarization switch for direct view stereoscopic display

(75) Inventors: Gary D. Sharp, Boulder, CO (US); Michael G. Robinson, Boulder, CO (US)

(73) Assignee: REALD INC., Beverly Hills, CA (US)

(21) Appl. No.: 13/032,466

(22) Filed: Feb. 22, 2011

Related U.S. Application Data
(60) Provisional application No. 61/306,897, filed on Feb. 22, 2010.

(51) Int. Cl. G02F 1/1335

(52) U.S. Cl. 349/15; 349/117

(57) ABSTRACT

A system for stereoscopic display and a bendable polarization switch for use with a system for stereoscopic display provide alternately polarized left and right eye images. Viewers then wear polarization analyzing eyewear to correctly see the different images. More specifically, a bendable polarization switch may be laminated to the front of a system for stereoscopic display. The bendable polarization switch may be used with a modulator configuration that is compatible with various performance requirements in a manner that is a low-cost manufacturing friendly solution. Further, the bendable polarization switch is a robust polarization switch technology that is reliable in an environment where mechanical stresses are inevitably applied during product lifetime

### CROSS-REFERENCE TO RELATED APPLICATIONS

This application claims priority to U.S. Provisional Patent Application Ser. No. 61/306,897, filed Feb. 22, 2010, entitled “Plastic liquid crystal polarization switch for direct view stereoscopic display,” the entirety of which is herein incorporated by reference.

### TECHNICAL FIELD

This disclosure generally relates to flat panel displays, and, more specifically, this disclosure relates to a low-cost and robust large-area modulator configuration that is compatible with the flat panel display systems. Such modulators are particularly useful for sequential stereoscopic display using passive eyewear.

### BACKGROUND

Active matrix liquid crystal display (AMLCD) is the most pervasive information display technology, from hand-held units to big-screen televisions, yet currently no methods are available for enabling a high quality stereoscopic 3D experience. Methods that can be implemented on the current installed base, such as anaglyph, compromise color quality as a means of delivering depth information. As such, they are not considered to represent a high quality stereoscopic experience. Furthermore, future products are expected to enable high quality 3D without compromising performance when showing 2D content. Any materials laminated to the face of a television for 3D purposes, for instance, should not produce perceptible artifacts when showing 2D imagery.

There are currently two accepted conventional approaches to implementing direct-view stereoscopic 3D display, which are based on either spatial or sequential methods. The spatial method involves dedicating odd lines of the display to one perspective (e.g., left-eye) imagery, with even lines dedicated to another perspective (e.g., right-eye) imagery. This can be done by laminating a transparent patterned birefringent element (or retarder mask) to the display surface. The mask has a quarter-wave of retardation, alternating between orthogonal orientations, producing alternate handedness circular polarization. The imagery is thus observed through eyewear with passive circular polarization analyzers. Benefits of this approach are that the display produces 3D imagery at standard video rates, and in principle no losses occur with 2D performance. But in practice, a black striped mask is introduced to increase vertical viewing range which compromises 2D brightness and often introduces noticeable black interference bands across the display. Furthermore, the spatial method halves the resolution of the display in 3D mode. Finally, registration of the mask to the display is challenging—adding cost to that already associated with fabrication of defect-free masks. An additional manufacturing difficulty is that each display model typically requires a specific size and pitch of the mask.

The sequential method involves the use of temporal (or time-separation) means for delivering the appropriate image to each eye. This is frequently accomplished using shutter-glasses, where spectacles containing lenses with individually addressable liquid crystal shutters operate synchronously with the content displayed on the screen. Benefits of this method are that loss in 2D performance is substantially nil, and the display bill-of-materials has very little change, which allows consumers to purchase an after-market kit to enable 3D. The sequential method has substantially no loss in 3D spatial resolution, but uses a display providing sufficient temporal separation of left/right images when operating at twice video frame rates. A tradeoff between brightness and cross-talk results due to the insufficient addressing and LC switching times. Frequently, the duty cycle for viewing is quite low due to these factors because the display cannot be viewed (or illuminated) until the entire image has settled.

In one shutter-glass embodiment, the lenses are self-contained shutters and, as such, can beat against other modulated light sources present in the viewing environment. This can create objectionable flicker noise, which can be very problematic. The benefit of this approach is that contrast is preserved under head tilt. Alternatively, and recognizing that an AMLCD display already contains a linear analyzing polarizer, the lens of the shutter glass can omit the input polarizer. This allows the lens to modulate intensity of light coming from the display, with zero modulation of surrounding input unpolarized light. This arrangement makes the shutter contrast much more sensitive to head tilt and to any birefringent elements, such as LCD cover glass, that may reside between the display analyzing polarizer and the shutter glass input. However, such an arrangement is no more sensitive to head-tilt than a typical cinema system using passive linear eyewear. Introducing crossed quarter wave retardation films to the display and eyewear improves tolerance to head tilt.

A further objection to shutter-glass stereoscopic systems is that the eyewear is relatively cumbersome, heavy, and uncomfortable. The batteries need frequent recharging, and damage to the LC cells and drive elements can occur when they are dropped. From a performance standpoint, the lenses are frequently small (to reduce cost) and the see-through of the lens is relatively poor due to the conductive layers, spacers, and reflections from the glass surfaces. The lenses are restricted to planar form, as there is no successful process for thermo-forming LC lenses. Accordingly, a practical method to implement stereoscopic 3D using industry-standard direct-view display technologies is needed.

### SUMMARY

Systems for displaying stereoscopic imagery are provided, including a flat panel display assembly operable to display stereoscopic imagery and a bendable polarization switch used for stereoscopic display systems.

The flat panel display assembly includes a backlight unit operable to provide light, an input polarizer operable to polarize the light provided by the backlight unit, a liquid crystal modulation panel positioned to receive the light from the input polarizer and operable to modulate the light received from the input polarizer, an output polarizer operable to block a portion of the modulated light from the liquid crystal modulation panel and to pass another portion of the modulated light from the liquid crystal, a pressure sensitive adhesive layer disposed on a surface of the output polarizer opposite the liquid crystal modulation panel, and a bendable polarization switch operable to receive light from a surface of the output polarizer opposite the liquid crystal modulation panel.

According to an aspect, the bendable polarization switch and output polarizer are laminated together using a pressure roller and are laminated to the output of the liquid crystal modulation panel.

According to another aspect, the assembly includes a pressure sensitive adhesive layer disposed on a surface of the outer polarizer opposite the liquid crystal modulation panel.

According to another aspect, the bendable polarization switch is laminated to the surface of the output polarizer opposite the liquid crystal modulation panel using the pressure sensitive adhesive layer.

According to another aspect, the liquid crystal modulation panel comprises an active matrix liquid crystal panel.

According to another aspect, the assembly includes an anti-glare layer disposed on an outer surface of the bendable polarization switch.

According to another aspect, the bendable polarization switch includes first and second bendable substrate retarder layers and a liquid crystal layer disposed between the first and second bendable substrate retarder layers.

According to another aspect, the bendable polarization switch includes first and second bendable isotropic substrate layers, a liquid crystal layer disposed between the first and second bendable isotropic substrate layers, and a bendable retarder layer.

The bendable polarization switch includes first and second bendable substrate retarder layers and a liquid crystal layer disposed between the first and second bendable substrate retarder layers. The bendable switch may alternatively include first and second bendable isotropic substrate layers, a liquid crystal layer disposed between the first and second bendable isotropic substrate layers, and a bendable retarder layer.

According to an aspect, the liquid crystal layer is a polymer stabilized liquid crystal layer.

According to another aspect, the bendable retarder layer may be a thin retarder film, and may be laminated to the first or second bendable isotropic substrate layer using a pressure sensitive adhesive layer.

According to another aspect, the bendable retarder layer may be a chemical coating layer applied on one of the first and second bendable isotropic substrate layers.

According to another aspect, the bendable polarization switch may include an anti-glare layer disposed on an outer surface of the bendable polarization switch. According to another aspect, the bendable polarization switch may include a pressure sensitive adhesive layer disposed on one the first or second bendable isotropic substrate layers and a release liner disposed on the pressure sensitive adhesive layer opposite the first or second bendable isotropic layer. The release liner is operable to be removed revealing the pressure sensitive adhesive layer.

### BRIEF DESCRIPTION OF THE DRAWINGS

FIG. 1 is a flow diagram illustrating an exemplary manufacturing process, in accordance with the present disclosure;

FIG. 2 is a schematic diagram illustrating a cross-sectional view of a preferred embodiment of a flat panel display assembly with a bendable polarization switch, in accordance with the present disclosure;

FIG. 3 is a schematic diagram illustrating a cross-sectional view of one embodiment of the bendable polarization switch, in accordance with the present disclosure;

FIG. 4 is a schematic diagram illustrating a cross-sectional view of another embodiment of a bendable polarization switch, in accordance with the present disclosure;

FIG. 5 is a schematic diagram of a cross-sectional view of a polarization switch with a buried touch screen assembly, in accordance with the present disclosure;

FIG. 6 is a schematic diagram of a cross-sectional view of a polarization switch buried beneath a touch screen assembly, in accordance with the present disclosure; and

FIG. 7 is a schematic diagram illustrating a top view of a plastic polarization switch, in accordance with the present disclosure.

### DETAILED DESCRIPTION

One technique of overcoming the objections of shutter-glass systems involves decomposing the shutter, such that a modulator portion resides at the image generating unit, with passive decoding polarization eyewear at the viewer. This arrangement is described in commonly-owned U.S. Pat. No. 6,975,345, which is herein incorporated by reference. With passive eyewear, the above objections can be substantially eliminated. Light weight, low-cost, comfortable, thermoformed polarizing eyewear may now be worn by the viewer, with a polarization modulating unit attached to the face of the AMLCD. A challenge involved with this technique is that the area of the polarization modulator is substantially identical to that of the image generating unit. Fabricating a large glass LC polarization switch, laminating additional polarization functional layers to the switch, and attaching it to the face of the LCD is likely to add prohibitive cost to the display bill-of-materials. In the event that an optical full-face bond between the units is desired to achieve adequate performance, there are few technologies allowing rigid-to-rigid lamination at an acceptable price.

Based on these considerations, the present disclosure recognizes a need to identify a large-area modulator configuration that is compatible with the performance requirements of such systems, in a manner that is a low-cost manufacturing friendly solution. The present disclosure also recognizes a need to identify a robust polarization switch technology that is reliable in an environment where mechanical stresses are inevitably applied during product lifetime. A polymer ferroelectric liquid crystal (FLC) polarization switch, developed by Idemitsu, utilized polymer substrates and a shear-alignment method, followed by ultraviolet (UV) cure. The approach enabled 3D display on CRT displays operating at twice video rates. The polarization switch enjoyed the benefit of a high switching speed, but was highly fragile, and thus unsuitable for consumer use. Pressure applied to the substrate permanently collapses the cell and destroys the alignment.

A performance benefit is enjoyed when reflections from index-mismatched surfaces are kept to a minimum. Consequently, and in addition to other benefits, laminating the LC modulator unit to the output face of the AMLCD is desirable. This is best done using an adhesive that is water clear and well index matched to both the display exit substrate and the modulator input substrate. In an embodiment, display outer surfaces free of additional coatings, such as anti-glare coatings, are preferred here. When the surfaces are rigid, a mechanical consideration allows for the adhesive to mitigate the affect of any stress that can otherwise develop as a consequence of the mounting process, shrinkage, or mismatch in coefficient of thermal expansion (CTE). When not properly managed, such stresses can cause non-uniformity in the modulator cell gap and induce substrate birefringence, impacting 3D contrast performance. Ultimately, such mechanical loads can produce voids in the cell, which represent regions without polarization modulation, and frequently lead to ultimate failure.

Exemplary processes for rigid-to-rigid optical bonding, particularly suitable for dissimilar materials, have been developed, as disclosed in commonly-owned U.S. Pat. Pub. No. 2009/0186218, herein incorporated by reference. While such processes produce high quality optical bonds with minimal induced stress, the compliant laminating agent is typically thick (and heavy), the process is not conducive to high manufacturing throughput, and the added cost is likely prohibitive for a consumer product.

According to the present disclosure, a rigid-to-rigid bond is eliminated by fabricating a polarization modulator using flexible substrates. The exemplary modulator is fabricated in such a way that it is durable enough to withstand the pressures associated with conventional lamination processes using pressure-sensitive-adhesives (PSAs). Such a process is rapid, low-cost, and uses equipment that may be used for laminating polarizers and compensation films in AMLCD manufacturing. Additionally, the physical properties of the substrates, and the compliance of the attachment method, minimizes or substantially eliminates observable stress-birefringence induced in the modulator over the operating temperature range due to CTE mismatch.

In conventional polarization switches, a quarter-wave bias retarder (e.g., positive A-plate, or positive uniaxial in-plane retarder) is typically laminated to the glass substrate using a PSA, with stretching direction orthogonal to the rubbing direction of the alignment layer. When the electric field amplitude is modulated across the LC variable retarder, a half-wave of retardation swing (e.g. 250-280 nm) is produced. As this is differenced with respect to the bias retarder, the behavior of the composite is that of a quarter-wave retarder with optic axis switchable between orthogonal orientations. In a preferred embodiment, the birefringence dispersion of the passive retardation is well matched to that of the liquid crystal fluid for maximum and balanced contrast in each eye. Such a switchable retarder approximates the behavior of the RealD ZScreen product, which uses two cells for a similar function. Consequently, similar passive eyewear can be used to decode the images.

A cell may also be fabricated using substrates that have virtually zero retardation in-plane, retaining it during the cell manufacturing and any subsequent processing. Suitable substrates such as TAC (tri-acetyl cellulose) may be used for protecting polyvinyl acetate (PVA) polarizer film from the environment. But one or more additional stretched polymer retarders should then be laminated to the stack using pressure sensitive adhesives (PSAs) in order to achieve optimum performance. The cost of additional retarder films, adhesives, and the lamination process step may be prohibitively expensive for a consumer product.

A preferred embodiment of the present disclosure is that the plastic LC polarization modulator has polarization control functionality integrated into the substrates. Additional polarization control may also be built into the LC polarization switch substrates in order to achieve optimum performance. For instance, the in-plane bias retardation value is typically adjusted slightly to remove residual retardation from the cell in the low-retardation state. This balances the net retardation between high and low voltage states, allowing use of conventional (e.g., RealD cinema) Circularly Polarized (CP) eyewear.

Also, field-of-view compensation can be beneficial for maximizing the 3D view angle, which can otherwise be limited by polarization cross-talk. Certain substrates (such as tri-acetyl cellulose and diacetates) are known to exhibit a negative uniaxial retardation in the thickness direction (or negative C-plate) in the absence of stretching. This thickness retardation, or Rth, is a figure commonly supplied by substrate manufacturers in the display industry. Alternatively, quasi-isotropic substrate material can be biaxially stretched as a synthetic means of controlling the anisotropy in three dimensions. Such products are typically specified by their Nz value—the ratio of retardation in the thickness direction to the in-plane retardation (see, e.g., “Polarization Engineering for LCD Projection,” Robinson et al., 2005). In practice, it is very difficult to obtain very high Nz values using biaxial stretching over large areas.

Proper in-plane retardation and field-of-view (FOV) compensation can be achieved by using biaxial stretching of materials such as polycarbonate, cyclic-olefin co-polymer (COC), PEN, PES, and others. True biaxially stretched substrates can directly provide a particular biaxiality, including a desired Rth value for field-of-view compensation. Alternatively, the substrates used to form the cell can provide a crossed positive A-plate function, where the different retardation provides the necessary in-plane retardation, and a negative C-plate function is provided in specific azimuth orientations.

According to the presently disclosed process, the polarization switches are preferably manufactured using as much roll-to-roll (r2r) processing as possible. By minimizing batch processes, the cost of the end product is potentially minimized. To best accomplish this, any polarization functionality built into the substrate should accommodate r2r mating of the two substrates to form the cell boundaries. Such requirements are discussed in the following examples.

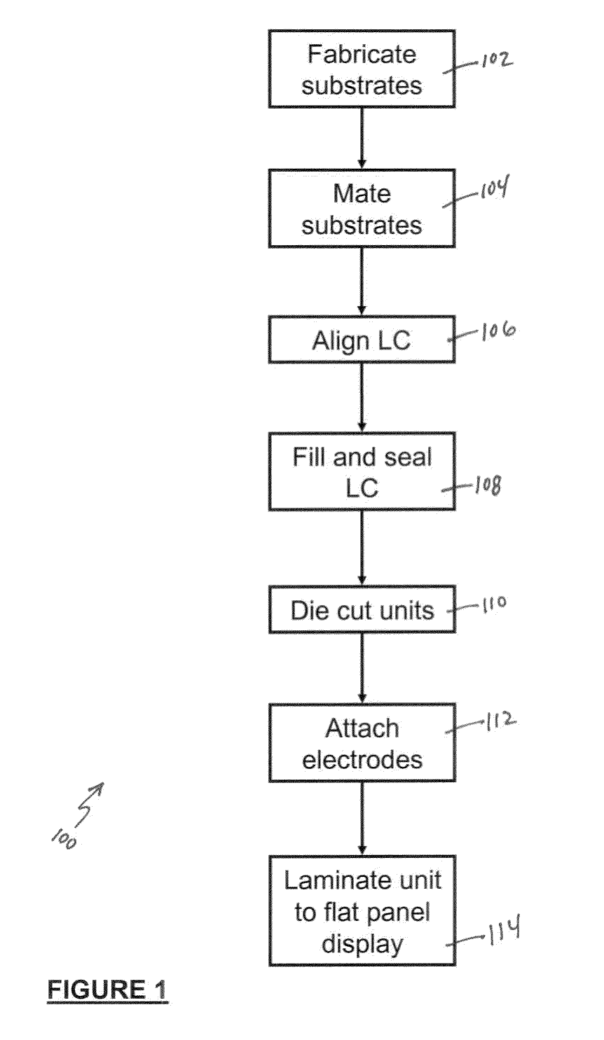

FIG. 1 is a flow diagram illustrating an exemplary manufacturing process 100. In manufacturing process 100, substrates are fabricated at action 102. In an embodiment, substrates may include uniaxial retarder films. In other embodiments, substrates may include isotropic substrates. Embodiments including isotropic substrates may further include laminating a retarder layer to the isotropic substrates or applying a chemical retarder coating to the isotropic substrates (not shown). Uniaxial retarder films are fabricated by heating quasi-isotropic film and stretching it in the machine direction (MD), or web direction, typically producing an optic axis (positive uniaxial) in the same direction. A polarization switch manufactured in this fashion is optimally used with a display having a 45-degree analyzer orientation to maximize usable area (or minimize scrap). In one preferred embodiment, each such substrate may be stretched to produce roughly ⅛-wave of retardation. One of the benefits of this approach is that the substrates are substantially matched mechanically. Specifically, stretching can introduce anisotropic mechanical properties, which can introduce stress when the films are not parallel aligned. The cell is formed by mating identical substrate films in the machine direction, again enabling r2r assembly at action 104. The liquid crystal (LC), which is typically positive uniaxial, is then aligned in the transverse direction (TD) or cross-web direction, which is crossed with the net quarter-wave passive retardation at action 106. One potential issue here is that LC alignment is conventionally achieved by physical rubbing of an alignment polymer (e.g. polyimide).

In the likely event that the most practical means of aligning the LC is via machine direction rubbing, it is preferable that machine direction substrate stretching either produce a positive uniaxial retardation in the transverse direction, or a negative uniaxial retardation in the machine direction. An alternative is to use transverse direction stretching to produce positive uniaxial retardation in the same direction. There are other alternatives, discussed in further embodiments, but they use a more sophisticated manufacturing process.

Once the substrates are paired and the LC is filled/sealed at action 108, the parts can be die-cut from the web at action 110. This can include a kiss-cut to expose conductors for electrical connection. Flexible electrodes are then heat sealed to the (left/right) perimeter ledges at action 112. A single ledge solution may use patterned conductors external to the active area to bring connections to a single side, which enables a single kiss-cut. The cell can then be PSA laminated directly to the AMLCD linear analyzing polarizer at action 114. Such an arrangement is thin, light-weight, and low-cost.

The above process 100 is an embodiment that is relatively straightforward to manufacture. Performance may be improved, for instance, by orienting the LCD polarizer parallel to an edge, using a more sophisticated manufacturing process in order to minimize scrap (i.e. cutting polarization switches that are rotated with respect to the web). Furthermore, there may be a need for field-of-view compensation or some other functionality integrated in to the polarization switch. Further examples are provided to illustrate how arbitrary polarization orientation and field-of-view compensation can be integrated into the package in a manner that facilitates r2r processing.

One approach to the polarizer orientation problem is to introduce off-machine direction stretching (or diagonal stretching). A process developed by the Polaroid Corporation, and then refined by companies such as Nippon Zeon, involves uniaxial stretching at angles other than the web direction. Present manufacturing processes demonstrate extreme accuracy in optic axis orientation and retardation value. As the process for stretching in directions other than the machine direction is somewhat flexible, it is possible to make the polarization switches in an r2r fashion, which accommodate the AMLCD polarizer orientation and optimize the performance with little material waste. One solution is thus to build the cell as described above, but with the common stretching direction as (e.g.) 45-degrees, rather than the machine direction. This further specifies that the LC be aligned at −45-degrees. Such configurations are possible by using photo-alignment materials rather than conventional rubbing. Alternatively, −45 degree rubbing can be done using a web operating in a step-and-repeat manner. The web advances the appropriate amount, stops and is held in place (e.g. vacuum), and the alignment layer is rubbed. The web advances and the process repeated.

The off-machine direction stretching (or diagonal stretching) process can also enable field-of-view compensation in the event that the desired Rth value must be achieve through stretching. Such compensation can be produced by the combined action of the substrates. For instance, one substrate can be uniaxial machine direction stretched, with the other transverse direction stretched, allowing r2r assembly of switches for 45-degree (display) polarizer orientation. The difference retardation establishes the amount of in-plane retardation, with effective Rth determined by the substrate mean retardation value. Such a configuration allows for machine direction rubbing for cell alignment, where the larger of the cell substrate retardation values is in the transverse direction.

In the event that a negative C-plate functionality is desired, and the polarization switch be aligned to a display polarizer that is parallel to an edge of the panel, it is desirable to build polarization switches with optic axis oriented at ±45° with respect to the edge using r2r processing. In a preferred embodiment, one substrate is stretched at +45°, with the other substrate effectively stretched at −45° (which can in principle be accomplished by flipping the roll and coating materials on the opposite side). Again, the difference retardation can provide the necessary in-plane retardation, with the Rth effectively determined by the substrate mean retardation value.

In another embodiment, the substrates are stretched as described above, but with (e.g.) negative C-plate functionality built into each substrate. This can be accomplished by r2r biaxial stretching using the process discussed above (e.g. a sequence of two uniaxial stretching steps along orthogonal directions), yielding roll-stock of substrate with desired biaxiality. In this case, the in-plane retardation values can either be additive or subtractive, depending upon the particular recipe. In another embodiment, the substrate may contain a desired retardation characteristic prior to any stretching process (e.g. cellulose diacetate possesses a negative C-plate retardation as-cast). Through either a sum or differencing scheme, the net effect of pairing the substrates in an r2r assembly process produces the desired polarization switch as described previously.

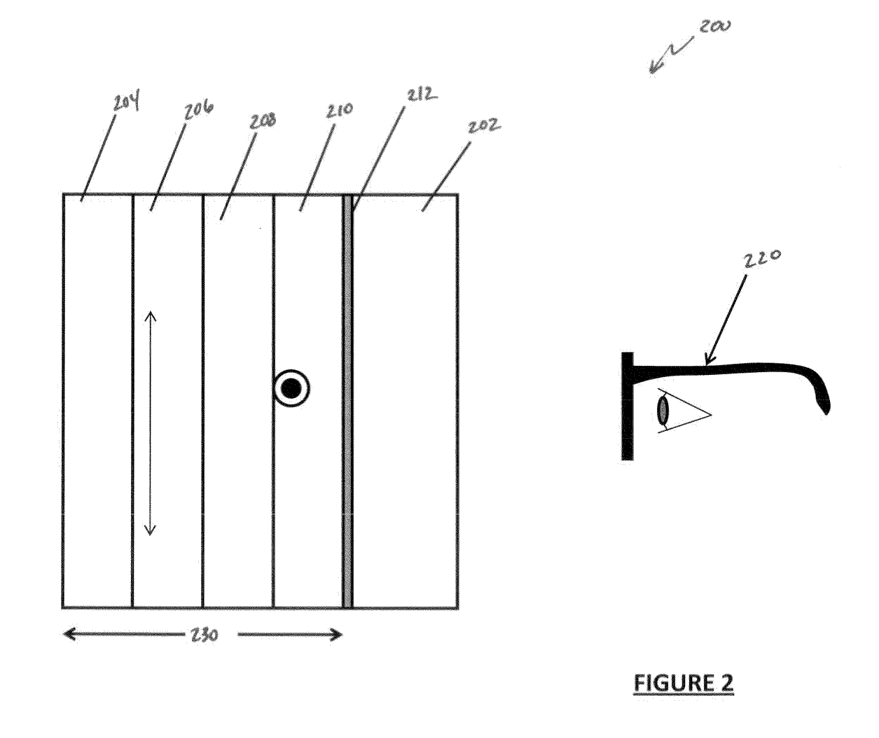

FIG. 2 is a schematic diagram illustrating a cross-sectional view of a preferred embodiment of a flat panel display assembly 200 with a bendable polarization switch 202. The flat panel display assembly 200 is operable to display stereoscopic imagery. The flat panel display assembly 200 includes a backlight unit 204, an input polarizer 206, a liquid crystal modulation panel 208, an output polarizer 210, a pressure sensitive adhesive layer 212, and a bendable polarization switch 202.

The backlight unit 204 provides light to the assembly. The input polarizer 206 may polarize the light provided by the backlight unit 204. The liquid crystal modulation panel 208 may be an active matrix liquid crystal panel. The liquid crystal modulation panel 208 is positioned to receive the light from the input polarizer 206 and modulates the light received from the input polarizer 206. The output polarizer 210 may block a portion of the modulated light from the liquid crystal modulation panel 208 and may pass another portion of the modulated light from the liquid crystal modulation panel 208. The pressure sensitive adhesive layer 212 is disposed on a surface of the output polarizer 210 opposite the liquid crystal modulation panel 208. And the bendable polarization switch 202 may receive light from the output polarizer 210 and may alter the state of polarization of the received light in synchronization with the modulated light from the liquid crystal modulation panel 208, resulting in a stereoscopic effect when viewed by a user 220 with passive eyewear.

In an embodiment, the bendable polarization switch 202 and output polarizer 210 are laminated together using a pressure roller and then laminated to the output of the liquid crystal modulation panel 208. In another embodiment, the assembly 200 also includes a pressure sensitive adhesive layer 212 disposed on a surface of the outer polarizer opposite the liquid crystal modulation panel. The bendable polarization switch 202 is laminated to the surface of the output polarizer 210 opposite the liquid crystal modulation panel 208 using the pressure sensitive adhesive layer 212.

In some embodiments, the bendable polarization switch 202 is laminated to the surface of the output polarizer 210 using a pressure roller. The pressure sensitive adhesive layer 212 is index matched to both an output of the output polarizer 210 and an input of the bendable polarization switch 202. In an embodiment, the assembly 200 includes an anti-glare layer (not shown) disposed on an outer surface of the bendable polarization switch 202.

The lamination of the bendable switch 202 to the display 230 can be accomplished in much the same way that an exit polarizer 210 is laminated to the display panel 208. One approach is to (PSA) laminate the polarizer 210 directly to the polarization switch 202, with a single lamination step (using a cosmetically known-good-laminate) being done on the AMLCD panel 208.

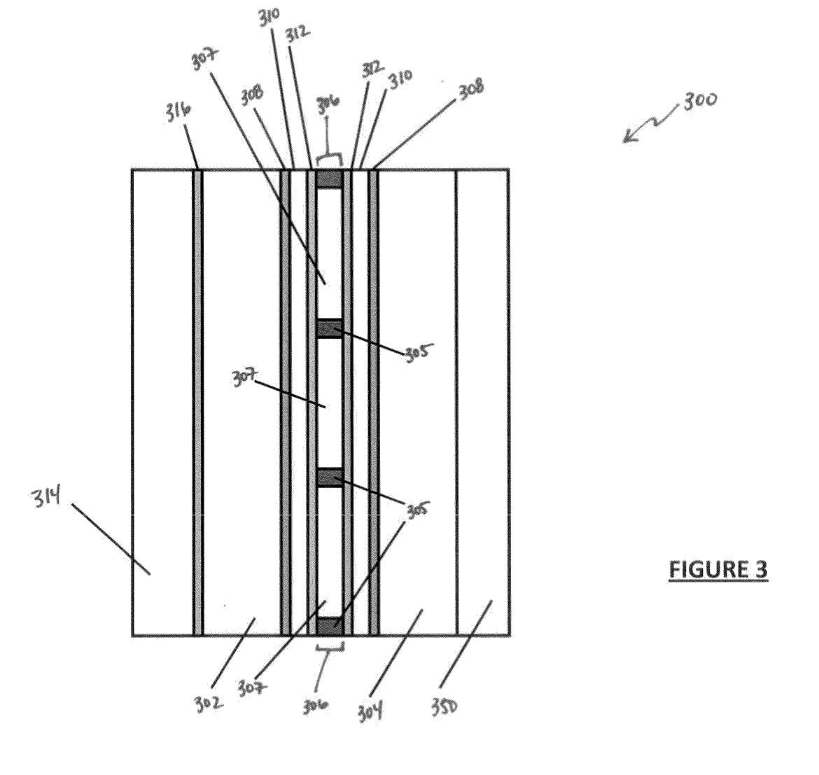

FIG. 3 is a schematic diagram illustrating a cross-sectional view of one embodiment of the bendable polarization switch 300. The bendable polarization switch 300 includes a first bendable substrate retarder layer 302 and a second bendable substrate retarder layer 304. A liquid crystal layer 306 is disposed between the first and second bendable substrate retarder layers 302, 304. In an embodiment, the liquid crystal layer 306 is made of polymer stabilized liquid crystals.

The liquid crystal layer may include liquid crystal fluid portions 307 that are operable to convert an electric field amplitude to a polarization state. The liquid crystal layer 306 may also include spacers 305 for maintaining local spacing of liquid crystal fluid portions 307.

The bendable polarization switch 300 may also include a first and a second barrier layer 308. The barrier layers 308 are between the first bendable substrate retarder layer 302 and the liquid crystal layer 306 and the second bendable substrate retarder layer 304 and the liquid crystal layer 306. The barrier layers 308 may substantially eliminate water/gas permeation to the LC layer 306.

The bendable polarization switch 300 may also include transparent conductive coatings 310 on either side of the liquid crystal layer 306 between the first and second barrier layers 308. The transparent conductive coatings 310 are operable to address the liquid crystal layer 306.

The bendable polarization switch 300 may also include alignment layers 312 on either side of the liquid crystal layer 306 between the transparent conductive coatings 310. The alignment layers 312 are for orienting the liquid crystal molecules in the liquid crystal layer 306.

In an embodiment, the bendable polarization switch 300 further includes a release liner 314 and a PSA layer 316. The release liner 314 would be stripped from the back of the switch 300 and the switch 300 may then be PSA laminated to an analyzing polarizer of a display panel. The bendable polarization switch 300 may also include an anti-reflective layer 350.

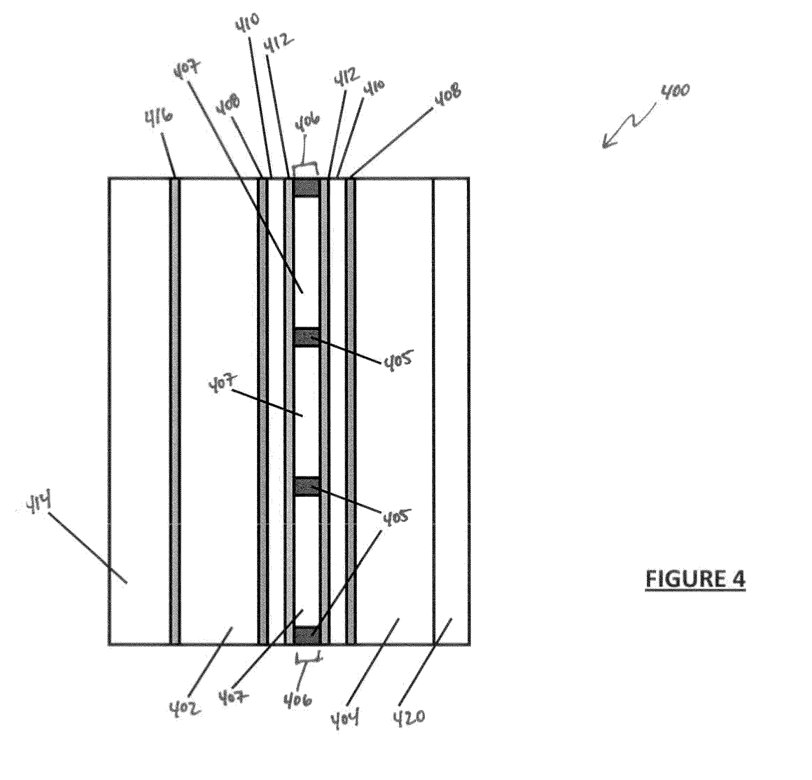

FIG. 4 is a schematic diagram illustrating a cross-sectional view of another embodiment of a bendable polarization switch 400. The bendable polarization switch 400 includes a first bendable isotropic substrate layer 402 and a second bendable isotropic substrate layer 404. A liquid crystal layer 406 is disposed between the first and second bendable isotropic substrate layers 402, 404. In an embodiment, the liquid crystal layer 406 is made of polymer stabilized liquid crystals.

The liquid crystal layer 406 may include liquid crystal fluid portions 407 that are operable to convert an electric field amplitude to a polarization state. The liquid crystal layer 406 may also include spacers 405 for maintaining local spacing of liquid crystal fluid portions 407.

The bendable polarization switch 400 may also include a first and a second barrier layer 408. The barrier layers 408 are between the first bendable isotropic substrate layer 402 and the liquid crystal layer 406 and the second bendable isotropic substrate layer 404 and the liquid crystal layer 406. The barrier layers 408 may substantially eliminate water/gas permeation to the LC layer 406.

The bendable polarization switch 400 may also include transparent conductive coatings 410 on either side of the liquid crystal layer 406 between the first and second barrier layers 408. The transparent conductive coatings 4310 are operable to address the liquid crystal layer 406.

The bendable polarization switch 400 may also include alignment layers 412 on either side of the liquid crystal layer 406 between the transparent conductive coatings 410. The alignment layers 412 are for orienting the liquid crystal molecules in the liquid crystal layer 406.

The bendable polarization switch 400 may also include a bendable retarder layer 420. In some embodiments, the bendable retarder layer 420 may be a thin retarder film laminated to an isotropic substrate layer 404 using a pressure sensitive adhesive layer (not shown). In other embodiments, the bendable retarder layer 420 may be a chemical coating layer applied an isotropic substrate layer 404.

In an embodiment, the bendable polarization switch 400 further includes a release liner 414 and a PSA layer 416. The release liner 414 would be stripped from the back of the switch 400 and the switch 400 may then be PSA laminated to an analyzing polarizer of a display panel.

Many of the preferred embodiments illustrate stack-ups that implement the desired display requirements with as few non-functional layers as possible, such as substrates that carry/support functional layers. Non-functional layers add cost, thickness and weight, while potentially degrading performance, such as efficiency and 3D contrast (i.e. polarization control). In a particular set of embodiments, a polarization switch technology is provided that supports conventional LCD functionality and appearance. In another set of embodiments, the polarization switch technology supports anticipated LCD display requirements. Examples of each are discussed in the following.

The outer surface of a current display can either be gloss or anti-glare (matte) depending upon desired product appearance. In modern LCDs, gloss surfaces can either be provided by the outer surface of the polarizer substrate (hard-coated tri-acetyl cellulose), or by an additional cover glass laminated above the polarizer. In the event that a cover glass is included, it should have minimal birefringence for it not to significantly reduce the 3D contrast. Either the tri-acetyl cellulose or cover glass can have functional coatings, such as anti-reflection layers to modify the reflection at the air-substrate interface.

In the event that a matte surface is desired, it is most cost effective to achieve this with an r2r process. Typically, the outer tri-acetyl cellulose substrate is embossed using a UV casting (or UV embossing) process. According to the present disclosure, such a UV embossing step can be applied directly as a coating to one of the cell substrates. The UV embossing process is preferred relative to other embossing methods (e.g. hot embossing), as certain processes induce stress birefringence that reduce contrast.

The cell construction, e.g., as shown in FIGS. 3 and 4, comprises a number of layers, which may include: (1) pressure sensitive adhesive for bonding to the display; (2) optically clear isotropic (or retardation functional) substrate, with suitable mechanical and thermal properties; (3) moisture/gas barrier layers as needed; (4) high transparency low resistivity stripe-patterned conductive coatings; (5) liquid crystal orientation (alignment) layer; (6) post, rib, (or randomly distributed) fiber/ball spacers; (7) LC fluid; (8) perimeter seal adhesive; (9) anti-glare coating (as needed); and/or (10) anti-reflection coating (as needed).

Processes for manufacturing the assemblies shown in FIGS. 2, 3, and 4 can, in principle, be accomplished in a wide-format r2r manufacturing environment (including cell assembly/filling). Back-end batch process steps include cutting the cells to final size, attaching electrodes, and lamination of the completed unit to the display surface.

An example of a display with further enhanced functionality includes a touch-screen technology. There are a variety of touch screen technologies, but the most pervasive are (1) resistive, (2) capacitive, and (3) surface acoustic wave (SAW). Each technology has relative performance advantages and disadvantages, and each poses different considerations with regard to integration with the polarization switch technology.

Resistive touch screen utilizes a pair of indium tin oxide (ITO) coated substrates spaced by a prescribed distance. Applied pressure collapses the cell, creating a point of low resistance and/or high capacitance. The xy location of the pressure is then detected externally. In principle, such a touch screen panel can be integrated directly into the polarization switch, with a suitable modification of the addressing structure. More specifically, the conductors used to address the liquid crystal polarization switch can serve the dual purpose of a resistive touch screen panel. Alternatively, in the event that the touch-screen and polarization switch panels form different units, either can form the outer structure of the display. If the polarization switch forms the outer structure, it should be sufficiently thin, yet mechanically robust, such that it can transfer pressure to the touch panel with adequate resolution. There are certain benefits to this approach. For instance, the touch screen conductors can have high reflectivity that degrades sunlight readability.

One solution is to use a circular polarizer to reduce glare, which typically uses a linear polarizer as the external functional layer. In an embodiment, such a touch screen is buried beneath the polarization switch

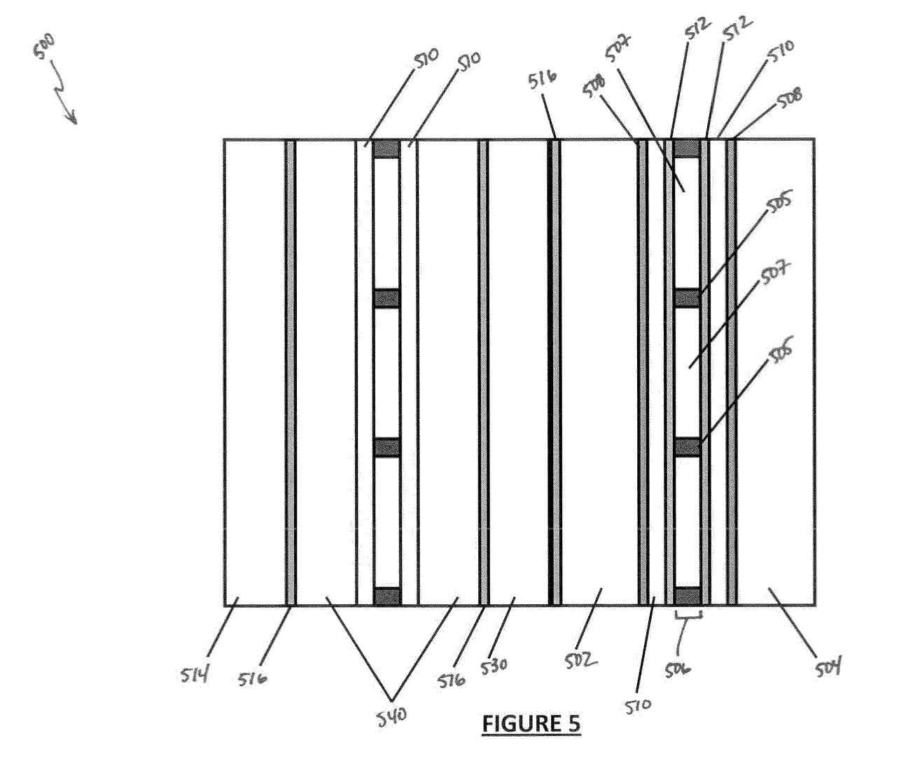

FIG. 5 is a schematic diagram of a cross-sectional view of a polarization switch with a buried touch screen assembly 500. In this arrangement, the touch-screen polarizer 530 (also the polarization switch input polarizer) is parallel to the AMLCD polarizer (not shown). The internal crossed quarter-wave A-plates provide the circular polarizer glare reduction while efficiently transmitting light from the AMLCD panel.

In an embodiment, the bendable polarization switch with a buried touch screen assembly 500 includes a first bendable substrate retarder layer 502 and a second bendable substrate retarder layer 504. A liquid crystal layer 506 is disposed between the first and second bendable substrate retarder layers 502, 504. In an embodiment, the liquid crystal layer 506 is made of polymer stabilized liquid crystals.

The liquid crystal layer may include liquid crystal fluid portions 507 that are operable to convert an electric field amplitude to a polarization state. The liquid crystal layer 506 may also include spacers 505 for maintaining local spacing of liquid crystal fluid portions 507.

The bendable polarization switch 500 may also include a first and a second barrier layer 508. The barrier layers 508 are between the first bendable substrate retarder layer 502 and the liquid crystal layer 506 and the second bendable substrate retarder layer 504 and the liquid crystal layer 506. The barrier layers 508 may substantially eliminate water/gas permeation to the LC layer 506.

The bendable polarization switch and touch screen assembly 500 may also include transparent conductive coatings 510 on either side of the liquid crystal layer 506 between the first and second barrier layers 508. The transparent conductive coatings 510 are operable to address the liquid crystal layer 506.

The bendable polarization switch 500 may also include alignment layers 512 on either side of the liquid crystal layer 506 between the transparent conductive coatings 510. The alignment layers 512 are for orienting the liquid crystal molecules in the liquid crystal layer 506.

In an embodiment, the bendable polarization switch and touch screen assembly 500 further includes a release liner 514 and PSA layers 516. The release liner 514 would be stripped from the back of the assembly 500 and the assembly 500 may then be PSA laminated to an analyzing polarizer of a display panel.

Although FIG. 5 shows a bendable polarization switch and touch screen assembly 500 using a polarization switch having bendable substrate retarders 502, 504, in the assembly 500 may also be implemented using a bendable polarization switch having isotropic substrates and a retarder layer, as discussed above in relation to FIG. 4.

Alternatively, the touch screen panel can form an external element, with the polarization switch buried beneath.

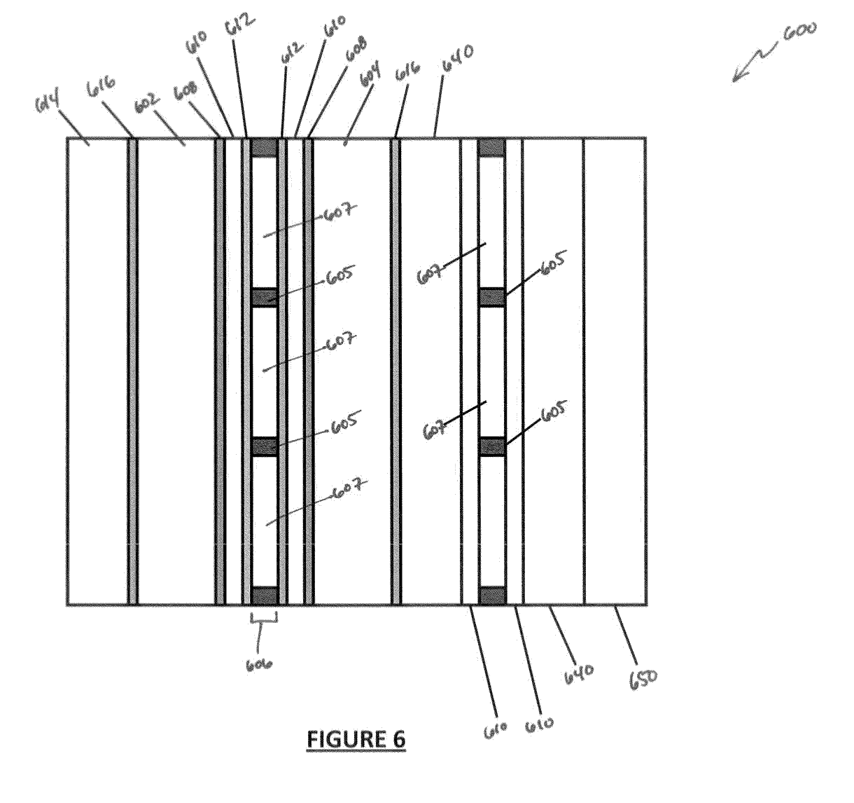

FIG. 6 is a schematic diagram of a cross-sectional view of a polarization switch buried beneath a touch screen assembly 600. This configuration may be used in the event that (e.g.) the polarization switch portion is not sufficiently durable to withstand the applied pressure. Care should be taken to ensure that substantially no birefringence is introduced by the touch-panel portion, so isotropic substrates 640 may be used. In principle, one isotropic substrate 640 can be omitted, along with one PSA lamination 616, by building the polarization switch and touch panel as a single unit.

In an embodiment, the bendable polarization switch and touch screen assembly 600 includes a first bendable substrate retarder layer 602 and a second bendable substrate retarder layer 604. A liquid crystal layer 606 is disposed between the first and second bendable substrate retarder layers 602, 604. In an embodiment, the liquid crystal layer 606 is made of polymer stabilized liquid crystals.

The liquid crystal layer may include liquid crystal fluid portions 607 that are operable to convert an electric field amplitude to a polarization state. The liquid crystal layer 606 may also include spacers 605 for maintaining local spacing of liquid crystal fluid portions 607.

The bendable polarization switch and touch screen assembly 600 may also include a first and a second barrier layer 608. The barrier layers 608 are between the first bendable substrate retarder layer 602 and the liquid crystal layer 606 and the second bendable substrate retarder layer 604 and the liquid crystal layer 606. The barrier layers 608 may substantially eliminate water/gas permeation to the LC layer 606.

The bendable polarization switch and touch screen assembly 600 may also include transparent conductive coatings 610 on either side of the liquid crystal layer 606 between the first and second barrier layers 608. The transparent conductive coatings 610 are operable to address the liquid crystal layer 606.

The bendable polarization switch 600 may also include alignment layers 612 on either side of the liquid crystal layer 606 between the transparent conductive coatings 610. The alignment layers 612 are for orienting the liquid crystal molecules in the liquid crystal layer 606.

In an embodiment, the bendable polarization switch and touch screen assembly 600 further includes a release liner 614 and PSA layers 6516. The release liner 614 would be stripped from the back of the assembly 600 and the assembly 600 may then be PSA laminated to an analyzing polarizer of a display panel.

The bendable polarization switch and touch screen assembly 600 may further include an anti-reflective layer 650.

Although FIG. 6 shows a bendable polarization switch and touch screen assembly 600 using a polarization switch having bendable substrate retarders 602, 604, the assembly 600 may also be implemented using a bendable polarization switch having isotropic substrates and a retarder layer, as discussed above in relation to FIG. 4.

Other touch-screen technologies may provide physical contact with the external face of the display and, as such, may be positioned as the exterior element. If the touch-screen layer is compatible with coating on a polymer substrate, it is preferably built into the polarization switch substrate (much like an anti-reflective or anti-glare film). Alternatively, a low-birefringence polymer substrate carrying the touch screen layer can be applied to the polarization switch using a PSA. Such a stack-up can then be applied to the AMLCD panel using a single PSA lamination. In the event that the touch-screen element is processed on glass, a low birefringence glass and rigid-to-rigid lamination process may be used.

There has been a concerted effort to develop LC displays on flexible substrates for a number of applications and markets. Certain of the developed solutions can be directly leveraged. Others that pose significant materials challenges are not relevant, which is beneficial to relaxing requirements. For instance, the present disclosure may provide for low resolution, one-dimensional electrical addressing of the modulator. This may be accomplished at the perimeter of the device using bulk electrical connections and discrete drivers. Conversely, flexible displays typically use either an LC mode (bistability) with passive matrix addressing, or more conventionally today, an active matrix thin-film transistor (TFT) structure.

Additionally, since the need for flexibility is simply to enable PSA lamination to a planar display panel, there is no subsequent need for the end product to be flexible. The radius requirements to enable lamination are modest, as is the down-force of a lamination roller. In principle, this allows the use of UV cast post or rib spacers, that may not be tolerable in applications using tight radiusing, or repeated bending of the device. UV cast spacers can provide a relatively deterministic support structure, assuring that there are substantially no voids that can occur in randomly distributed spacers. Moreover, post spacers simultaneously provide good mechanical integrity, combined with high transparency (low haze). High density of random spacers can frequently produce a significant scatter, which reduces the clarity of the transmission as well as the polarization contrast ratio. However, care should be taken to ensure that a deterministic structure does not impose a specific pitch or an accurate alignment of the modulator to the display to avoid artifacts (e.g. moire).

It is desirable, in accordance with the present disclosure, that the polarization modulator be manufactured using as much roll-to-roll (r2r) processes as possible, which can be much lower cost than batch processing. Processes such as stretching to produce substrate retardation (of arbitrary orientation), barrier layer, transparent conductor deposition/patterning (e.g. indium tin oxide), alignment layer coating/orientation, spacers, cell assembly, and (PSA) adhesive application can all be done in an r2r environment. To the extent that the pitch of the conductor stripes can be standardized for a range of product diagonal sizes, much of the r2r processing is independent of the particular end product dimensions and of pixel pitch. This greatly reduces the number of product offerings required to satisfy the market, versus retarder mask technology.

An important consideration in building the present polarization switch concerns substrate selection. Factors influencing decisions on substrate selection for building an LC device include: (1) transparency (internal transmission of visible light); (2) refractive index; (3) haze (internal scatter); (4) birefringence characteristics (as-manufactured); (5) birefringence dispersion; (6) stress-optic coefficient; (7) tensile strength/elongation; (8) glass transition temperature; (9) heat shrinkage (dimensional stability); (10) modulus; (11) gas permeability; (12) water absorption; (13) surface chemistry (i.e. compatibility with coating/adhesive technology); and (14) cost.

An exemplary substrate material for building a polarization switch is cyclic-olefin-copolymer (COC), supplied by manufacturers such as Nippon Zeon and JSR, which possesses good optical properties, relatively good mechanical properties, high Tg, and low water/gas permeability. Once stretched, it forms a robust retarder that is relatively insensitive to stress.

Another exemplary substrate material is flexible glass. A micro sheet of flexible glass (e.g., Corning microsheet glass) is functionally equivalent to a polymer in the polarization switch. Flexible glass may be processed at high temperatures, is inert, and does not require the use of barrier layers. In principle coating and assembly can occur in a r2r fashion using thermal process conditions that are substantially identical to those used for batch glass cell manufacturing. Since flexible glass materials cannot provide retardation functionality, additional layers are used. To maintain a thin polarization switch, one approach is to r2r coat retarder materials (such as liquid crystal polymer) onto the flexible glass substrate prior to assembly. Such coatings can be sub-micron, so they insure that the package remains thin and light weight.

One of the issues with plastic substrates concerns moisture and gas permeability. There are a number of thin film barrier layers that are r2r compatible. When used, the coating technology should be substantially free of pinhole defects. Depending on the substrate choice, there is preferably no need for a barrier layer with a direct-drive cell (i.e. no TFT). If used, an acceptable solution may be a single layer barrier, such as a reactive atomic layer of aluminum oxide (DuPont), or Si:C (Dow Corning). Lower rates of water permeation, preferably not required, are associated with multi-layer (organic/inorganic stack) coatings that are relatively expensive.

Exemplary transparent conductive coatings produce low sheet resistivity (<100 ohms/square-centimeter) in very thin (tens of Angstroms) layers and are compatible with flexible LCD realizations. Currently, Indium Tin Oxide (ITO) is the transparent conductor of choice for the AMLCD industry, with other examples being fluorine-doped tin-oxide and aluminum-doped zinc-oxide. ITO coating on glass entails an inexpensive sputtering/evaporative process, usually using high annealing temperatures to achieve low sheet resistivity values. Even the highest quality ITO films have combined reflectivity/absorption values of several percent per layer in assembled liquid crystal cells. Reflections give rise to Fabry-Perot fringes in cells, which further enhance localized reflection. Even with modest non-uniformity in cell gap, this causes objectionable non-uniformity in luminance and coloration when viewing the display device. Moreover, ITO is brittle and thus not particularly compatible with flexible substrates. However, it is feasible that a low-temperature ITO process on plastic may be suitable for the present polarization switch. In an embodiment, indexed matched ITO is used for reducing reflections.

There are processes under development for printing conductive coatings onto substrates to achieve low sheet resistivity. These materials can in principle be printed onto flexible substrates using r2r processing, and are thus preferred for implementing the inventive polarization switch. Printable conductive materials are under development for solar-cells, switchable windows, and flexible electronic paper, for example. These materials include PEDOT-PSS, carbon nano-tubes, graphine, and silver nano-wires, among others. Exemplary conductor technologies produce both acceptable resistivity and high transparency.

The particular LC mode depends upon the alignment material and processing, which determines pretilt and anchoring energy, along with relative rubbing direction, and whether or not chiral dopants are added. As with conductor coating, alignment layers (e.g. polyimide) typically using high annealing temperatures. Given that any polymer substrate will have a relatively low thermal processing budget, it is preferable that the appropriate alignment is achieved with as low a processing temperature as possible. There are preimidized polyimide alignment layers that can be processed near room-temperature, and other polyimides that can be annealed below the cyclic-olefin-copolymer (COC) Tg.

When building high-speed LC variable retardation devices (such as pi-cells), cell gap control is important for ensuring a spatially uniform retardation value, which translates to contrast uniformity. A robust manufacturing process ensures local support of the cell gap via a deterministic spacer technology. According to a preferred embodiment, r2r processes are utilized after coating the conductive material, to define an array of spacer elements. Ideally, a UV casting process could be used for depositing both an alignment structure and a spacer. Alternatively, discrete spacers can be deposited onto a substrate in arbitrary patterns using one of several printing processes. Spacer balls in a cross-linkable binder can be printed onto the substrate with a similar functionality to the UV cast pillars.

Barrier layers may additionally be used as a means of ensuring the lifetime of the cell. Diffusion of gas or moisture through the substrate can eventually lead to product failure. Substrate barrier layer coatings (such as ceramic multi-layers) are commonly needed, for instance in the organic light emitting diode industry, and depending upon physical properties of the substrates, may also be used for the inventive polarization modulator. Given the high performance of COC substrates in impeding moisture/gas permeation, it is feasible that barrier layers can be avoided.

In a preferred embodiment, the LC polarization switch is based on a parallel-rubbed nematic, or pi-cell. Pi-cells are characterized by fast relaxation (to the half-wave retardation state), and function as variable retarders, as preferred for the present application. Again, the switched-retarder behavior offered by a variable retarder enables the use of conventional circular polarizer eyewear. Pi-cells are also characterized by a particular azimuth dependence in behavior (much like many LC modes). In a preferred embodiment, the rub direction of the cell is parallel to the display horizontal. This either requires a display with a 45-degree polarizer, or polarization coordinate transforming element (i.e. a 45-degree polarization achromatic rotator). If this is not feasible, compensation films can be used to mitigate the effects of contrast loss, as discussed previously.

Nematic LC modes can be polymer stabilized where the LC material is dispersed but remains aligned within a loose polymeric matrix. The bulk LC alignment decreases relaxation times by often an order of magnitude making them particularly attractive for fast polarization modulation devices. In the case of r2r manufacturing, polymer stabilized nematic LC modes offer certain advantages including simplified alignment and sealing. Alignment of polymer stabilized modes is achieved ‘on-the-fly’ by the natural shearing of the substrates as they pass through one or more sets of S-shaped rollers. This alleviates the need for conventional polyimide coating, curing and brushing, significantly simplifying r2r fabrication. Sealing the LC cells using a gasket patterning is also avoided since the UV polymerized material naturally contains the LC fluid and adheres together the two flexible substrate materials forming a durable device structure that is tolerant to handling.

In the event that the pi-cell mode is not feasible, other more conventional LC modes are possible. This includes twisted nematic (TN), super-twist nematic (STN), vertical alignment (VA), hybrid aligned nematic (HAN), or anti-parallel aligned nematic (homogeneous nematic, or electrically-controlled birefringence (ECB)). The latter three are also variable retarders, but neither switches to the relaxed state as rapidly as a pi-cell. Moreover, the FOV in their driven state can be poor.

STN devices, like variable retarder modes, typically dictate accurate cell gap control in manufacturing to create a uniform appearance. However, they do not function as variable retarders. A feature of the STN device is that it can exhibit bistability, which can be beneficial in terms of designing the drive circuitry.

A benefit of the TN mode is that it is relatively insensitive to cell gap, is generally easier to manufacture, and can be addressed with low-voltage drivers. A general challenge with the twisted modes (TN, STN) is that they do not function as variable retarders. In principle, the eyewear lenses can be modified such that the off-state contrast is preserved, with color balance adjustments made by the display to compensate for any issues in the on-state. However, it is preferred that the polarization switch enable the use of standard CP eyewear.

It is anticipated that there will be a strong effort in the near future to standardize eyewear, such that a standard circularly polarized lens can be used across several home and cinema platforms with virtually no perceived performance loss. The present de-facto standard for cinema is the RealD circularly polarized eyewear, having a pair of linear horizontal transmission analyzers, which are proceeded by crossed quarter-wave retarders. The left (positive uniaxial) lens has the slow axis at −45-degrees, with the right lens slow axis at +45-degrees, as seen by the observer. Were it necessary for a consumer direct view product to use the same eyewear, suitable adjustments can be made to the design of the LCD and polarization switch to enable it. Preferably, the LCD analyzer transmission axis is vertical, meaning that the polarization switch modulate between +45 and −45 orientations. The actual orientation of the passive retarder is of little consequence, since delivering the appropriate content to each eye simply dictates selecting the phase of the drive signal.

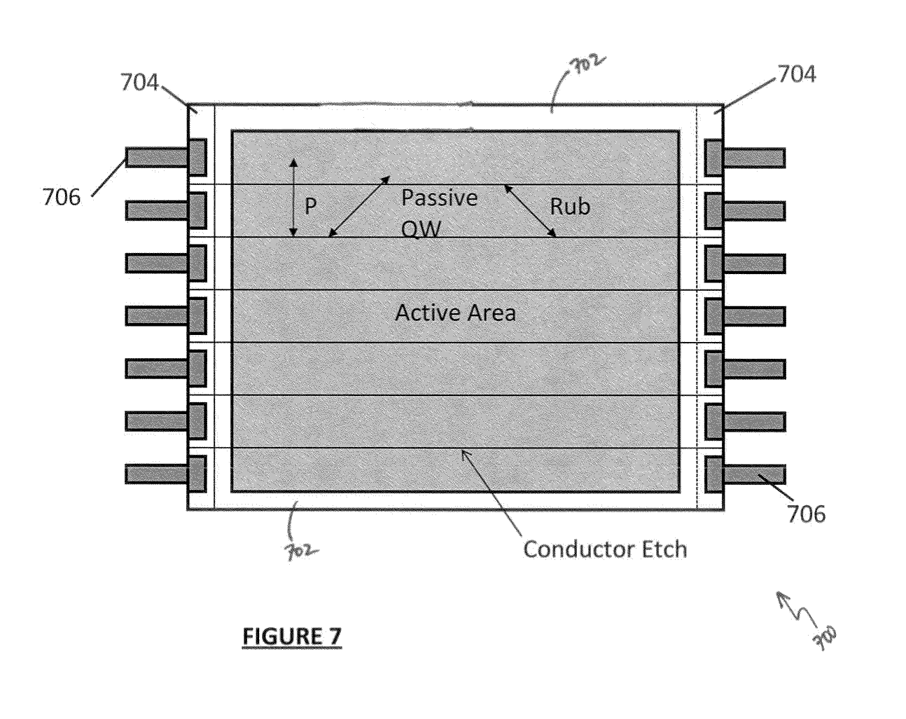

FIG. 7 is a schematic diagram illustrating a top view of a plastic polarization switch 700. The switch 700 includes a gasket area 702 and a ledge 704 with flexible connectors 706. The flexible connectors 706 are electrodes for addressing individual parts of the LC display so that the polarization switch 700 may follow the addressing of the LC display.

A flexible polarization switch has the potential to offer other product features. A device that can be curved about one axis has the potential to offer improved field-of-view. In a plane where the device shows particular angular dependence, or uses a particularly large acceptance angle, curvature about an axis perpendicular to that plane can substantially improve performance. In this case, the radius of curvature of the device is substantially matched to that of the converging/diverging light source. This ensures that each ray is incident on the device at roughly normal incidence, where contrast is typically maximized.

With a flexible polarization switch, there is also the potential to introduce compound curvature as a means of achieving this result in a broader range of azimuth angles. Given that the device is manufactured in planar form, there is therefore a need for a forming process that will map the device geometry onto a compound curved (e.g. spherical) surface. There is a potential to thermoform the polarization switch in a manner similar to manufacturing polarization eyewear lenses. In view of the robustness of the inventive polarization switch, the ability to preserve the polarization transforming properties when subjected to heat and (e.g. radial) stress associated with the forming process is optimum.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A flat panel display assembly operable to display stereoscopic imagery, comprising:
a backlight unit operable to provide light;
an input polarizer operable to polarize the light provided by the backlight unit;
a liquid crystal modulation panel positioned to receive the light from the input polarizer and operable to modulate the light received from the input polarizer;
an output polarizer operable to block a portion of the modulated light from the liquid crystal modulation panel and to pass another portion of the modulated light from the liquid crystal;
a pressure sensitive adhesive layer disposed on a surface of the output polarizer opposite the liquid crystal modulation panel; and
a bendable polarization switch operable to receive light from a surface of the output polarizer opposite the liquid crystal modulation panel.

2. The flat panel display of claim 1, wherein the bendable polarization switch and output polarizer are laminated together using a pressure roller and are laminated to the output of the liquid crystal modulation panel.

3. The flat panel display of claim 1, further comprising a pressure sensitive adhesive layer disposed on a surface of the outer polarizer opposite the liquid crystal modulation panel.

4. The flat panel display of claim 3, wherein the bendable polarization switch is laminated to the surface of the output polarizer opposite the liquid crystal modulation panel using the pressure sensitive adhesive layer.

5. The flat panel display of claim 1, wherein the bendable polarization switch is laminated to the surface of the output polarizer using a pressure roller.

6. The flat panel display of claim 1, wherein the liquid crystal modulation panel comprises an active matrix liquid crystal panel.

7. The flat panel display of claim 1, wherein the pressure sensitive adhesive layer is index matched to both an output of the output polarizer and an input of the bendable polarization switch.

8. The flat panel display of claim 1, further comprising an anti-glare layer disposed on an outer surface of the bendable polarization switch.

9. The flat panel display of claim 1, wherein the bendable polarization switch comprises:
first and second bendable substrate retarder layers; and
a liquid crystal layer disposed between the first and second bendable substrate retarder layers.

10. The flat panel display of claim 9, wherein the liquid crystal layer comprises a polymer stabilized liquid crystals.

11. The flat panel display of claim 9, wherein the liquid crystal layer comprises:
liquid crystal fluid portions operable to convert an electric field amplitude to a polarization state; and
spacers for maintaining local spacing of liquid crystal fluid portions.

12. The flat panel display of claim 11, wherein the bendable polarization switch further comprises first and second barrier layers, the first barrier layer disposed between the first bendable substrate retarder layer and the liquid crystal layer and the second barrier layer disposed between the second bendable substrate retarder layer and the liquid crystal layer.

13. The flat panel display of claim 12, wherein the bendable polarization switch further comprises transparent conductive coatings disposed on either side of the liquid crystal layer between the first and second barrier layers, the transparent conductive coatings operable to address the liquid crystal layer.

14. The flat panel display of claim 13, wherein the bendable polarization switch further comprises alignment layers disposed on either side of the liquid crystal layer between the transparent conductive coatings.

15. The flat panel display of claim 1, wherein the bendable polarization switch comprises:
first and second bendable isotropic substrate layers;
a liquid crystal layer disposed between the first and second bendable isotropic substrate layers; and
a bendable retarder layer.

16. The flat panel display of claim 15, wherein the bendable retarder layer comprises a thin retarder film, and wherein the bendable retarder layer is laminated to one of the first and second bendable isotropic substrate layers using a pressure sensitive adhesive layer.

17. The flat panel display of claim 15, wherein the bendable retarder layer comprises a chemical coating layer applied on one of the first and second bendable isotropic substrate layers.

18. The flat panel display of claim 1, wherein the bendable polarization switch comprises flexible glass.

19. A bendable polarization switch, comprising:
first and second bendable substrate retarder layers; and
a liquid crystal layer disposed between the first and second bendable substrate retarder layers.

20. The bendable polarization switch of claim 19, wherein the liquid crystal layer comprises a polymer stabilized liquid crystals.

21. The bendable polarization switch of claim 19, wherein the liquid crystal layer comprises:
liquid crystal fluid portions operable to convert an electric field amplitude to a polarization state; and
spacers for maintaining local spacing of liquid crystal fluid portions.

22. The bendable polarization switch of claim 21, wherein the bendable polarization switch further comprises first and second barrier layers, the first barrier layer disposed between the first bendable substrate retarder layer and the liquid crystal layer and the second barrier layer disposed between the second bendable substrate retarder layer and the liquid crystal layer.

23. The bendable polarization switch of claim 22, wherein the bendable polarization switch further comprises transparent conductive coatings disposed on either side of the liquid crystal layer between the first and second barrier layers, the transparent conductive coatings operable to address the liquid crystal layer.

24. The bendable polarization switch of claim 23, wherein the bendable polarization switch further comprises alignment layers disposed on either side of the liquid crystal layer between the transparent conductive coatings.

25. A bendable polarization switch, comprising:
first and second bendable isotropic substrate layers;
a liquid crystal layer disposed between the first and second bendable isotropic substrate layers; and
a bendable retarder layer.

26. The bendable polarization switch of claim 25, wherein the bendable retarder layer comprises a thin retarder film, and wherein the bendable retarder layer is laminated to one of the first and second bendable isotropic substrate layers using a pressure sensitive adhesive layer.

27. The bendable polarization switch of claim 25, wherein the bendable retarder layer comprises a chemical coating layer applied on one of the first and second bendable isotropic substrate layers.

28. The bendable polarization switch of claim 25, further comprising an anti-glare layer disposed on an outer surface of the bendable polarization switch.

29. The bendable polarization switch of claim 25, further comprising:
a pressure sensitive adhesive layer disposed on one of the first and second bendable isotropic substrate layers; and
a release liner disposed on the pressure sensitive adhesive layer opposite the one of the first and second bendable isotropic layer, wherein the release liner is operable to be removed revealing the pressure sensitive adhesive layer.
